(19) United States
(12) Patent Application Publication
(10) Pub. No.: US 2002/0185071 A1
(43) Pub. Date: Dec. 12, 2002

(54) Apparatus for cleaning a teat of a dairy animal

(76) Inventor: Fangjiang Guo, Ithaca, NY (US)

Correspondence Address: HANCOCK & ESTABROOK, LLP, 1500 MONY Tower I, PO Box 4976, Syracuse, NY, 13221-4976, US

(21) Appl. No.: 09/876,007

(22) Filed: Jun. 8, 2001

(51) Int. Cl. A01J 5/04

(52) U.S. Cl. 119/14.47

(57) ABSTRACT

The present invention provides an apparatus for automatically cleaning a teat of an animal, such as a dairy cow. The apparatus generally includes a first housing having a longitudinal axis and an interior wall defining a teat cleaning compartment, a motor (or other powering device)operatively coupled to the first housing for imparting rotary motion thereto about its longitudinal axis, and a first set of bristles engaged with the interior wall and extending radially inward therefrom, wherein the rotary motion imparted to the first housing is translated to the first set of bristles. The apparatus further includes a second housing concentrically positioned around the first housing that includes a cleaning fluid inlet nozzle positioned in fluid communication with a cleaning fluid conduit, and a cleaning fluid discharge nozzle. A source of cleaning fluid is operatively connected to the cleaning fluid inlet nozzle, and a pressure source is operatively connected to the cleaning fluid discharge nozzle in order to draw the fluid out of the apparatus.

### BACKGROUND OF THE INVENTION

The present invention relates generally to apparatus for cleaning a teat of a milk producing animal, such as a dairy cow, and more particularly to such apparatus that automatically effects the cleaning operation.

In order to ensure the cleanliness of milk being drawn from an animal, it is necessary to clean the teat of the animal from which the milk is being drawn prior to the milking operation. Dairy cows, for instance, often lay in mud which may include bacteria embedded therein. Consequently, bacteria spores attach to the cow's teats and absent removal of the spores prior to milking, the bacteria would enter the teat, thereby causing infection to the cow, and furthermore, infect the milk being drawn from the teat. Accordingly, it is routine to clean the teats prior to effecting the milking operation.

Traditionally, teat cleaning (and milking) is done manually. A worker generally uses a paper or cloth towel and cleaning solution, and scrubs each teat prior to milking the animal. This process is, however, slow and labor intensive.

In recent years, apparatus for automatically cleaning an animal's teats (and automatically milking the animal) have been developed. Examples of prior art automatic teat cleaning apparatus can be readily seen in U.S. Pat. Nos. 5,235,937 and 5,211,132 both to Farina et al., U.S. Pat. No. 5,673,650 to Mottram et al., U.S. Pat. No. 4,305,346 to Sparr et al., and U.S. Pat. No. 4,034,714 to Umbaugh et al.

It is a principal object and advantage of the present invention to provide an automatic teat cleaning apparatus that quickly and effectively cleans an animal's teats prior to a milking operation.

It is another object and advantage of the present invention to provide an automatic teat cleaning apparatus that may be cost effectively manufactured.

It is a further object and advantage of the present invention to provide a teat cleaning apparatus that can be used manually by a human operator or automatically by a robotic milker.

Other objects and advantages of the present invention will in part be obvious, and in part appear hereinafter.

### SUMMARY OF THE INVENTION

In accordance with the foregoing objects and advantages, the present invention provides an apparatus for automatically cleaning a teat of an animal, such as a dairy cow. The apparatus generally comprises a first housing having a longitudinal axis and an interior wall defining a teat cleaning compartment, a motor (or other powering device)operatively coupled to the first housing for imparting rotary motion thereto about its longitudinal axis, and a first set of bristles engaged with the interior wall and extending radially inward therefrom, wherein the rotary motion imparted to the first housing is translated to the first set of bristles. The apparatus further comprises a second housing concentrically positioned around the first housing that includes a cleaning fluid inlet nozzle positioned in fluid communication with a cleaning fluid conduit, and a cleaning fluid discharge nozzle. A source of cleaning fluid is operatively connected to the cleaning fluid inlet nozzle, and a pressure source is operatively connected to the cleaning fluid discharge nozzle in order to draw the fluid out of the apparatus.

In operation, the teat of an animal, such as a dairy cow, is positioned within the first housing and cleaning fluid is injected through the inlet nozzle and through the conduit into the first housing. Afer a short delay (preferably about 0.5-1.0 seconds) the motor is actuated to rotate the first set of brushes around the animal's teat, thereby scrubbing the same. After a predetermined period of time the pressure source is actuated, thereby draining the cleaning fluid from the first housing. Clean fluid will continuously be introduced into the housing, thereby flushing the dirty fluid with clean fluid. The fluid flow will then stop. The pressure source and brushes will continue to operate, wherein the negative pressure created within the housing will help maintain the device in position, and the flow of air through the housing will serve to dry the teat. The brush and pressure source are then stopped. The process can then be repeated on the animal's other teats.

### BRIEF DESCRIPTION OF THE DRAWINGS

The present invention will be understood more fully by reading the following Detailed Description in conjunction with the accompanying drawings, in which:

FIG. 1 is a front elevational view of the present invention with an animal's teat positioned thereabove;

FIG. 2 is a top plan view of the present invention taken along line 2-2 of FIG. 1;

FIG. 3 is a cross-sectional view taken along line 3-3 of FIG. 1;

FIG. 4 is a top plan view of the brush housing portion of the present invention;

FIG. 5 is a perspective view of the present invention;

FIG. 6 is a cross-sectional view of the present invention taken along line 6-6 of FIG. 2;

FIG. 7 is an exploded perspective view of the present invention;

FIG. 8 is a bottom plan view of the brush housing element of the present invention taken along line 8-8 of FIG. 7; and

FIG. 9 is a top plan view of the outer housing element of the present invention taken along line 9-9 of FIG. 7.

### DETAILED DESCRIPTION

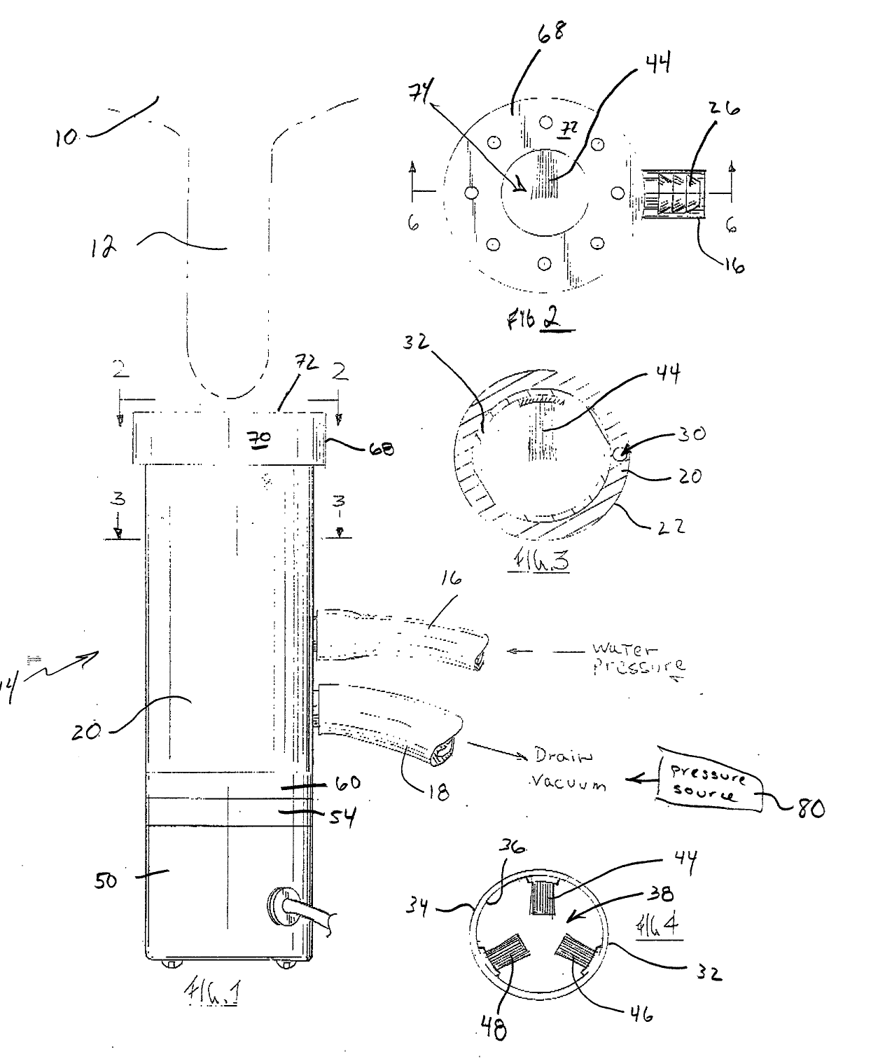

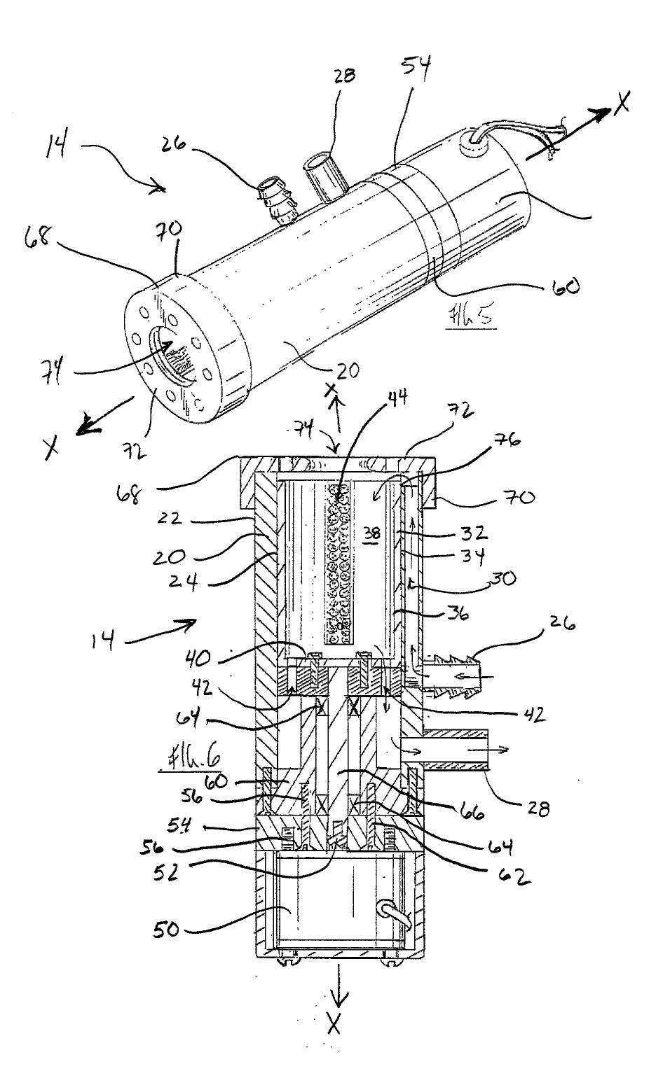

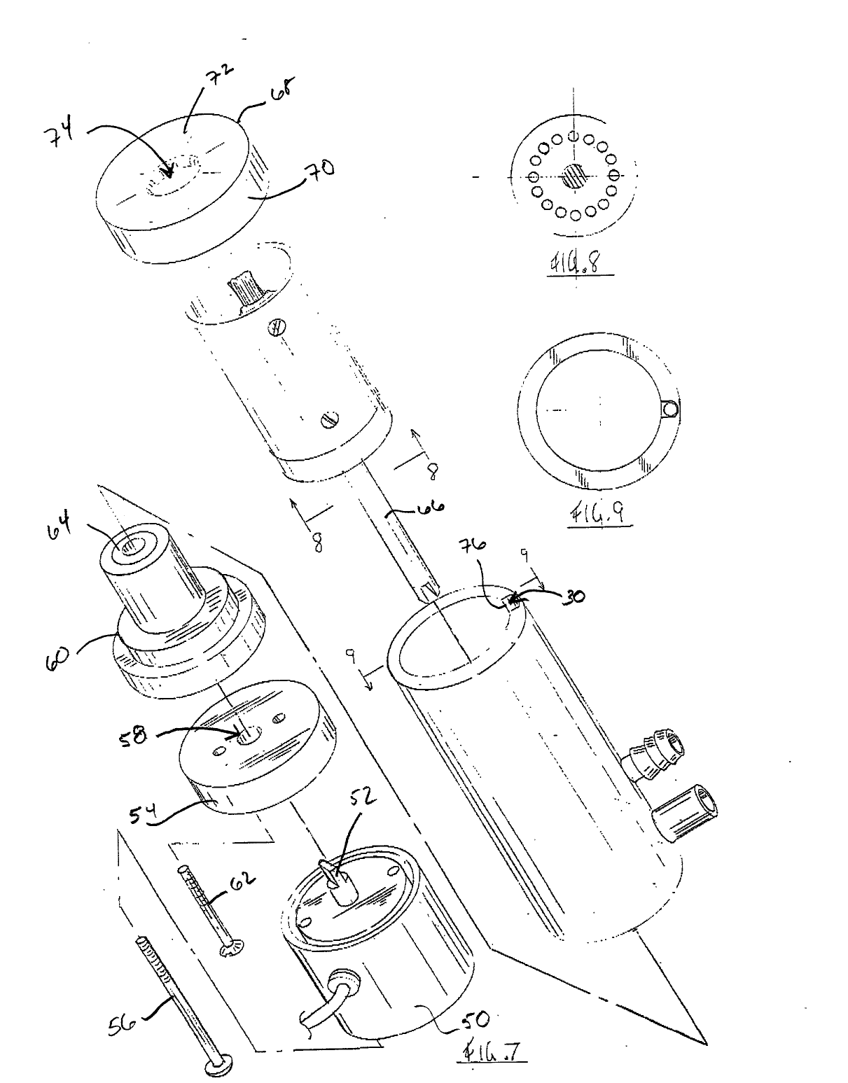

Referring now to the drawings, wherein like reference numerals refer to like parts throughout, there is seen in FIG. 1 an udder 10 and a teat 12 depending therefrom of an animal, such as a dairy cow. A teat cleaning apparatus (“teat cleaner”), denoted generally by reference numeral 14, is positioned directly beneath teat 12. Teat cleaner 14 extends along a longitudinal axis X-X, and comprises a first hose 16 for delivering cleaning fluid under pressure thereto, and a second hose 18 connected to a pressure source for draining the cleaning fluid therefrom and creating a negative pressure differential which permits a secure connection of the device to a teat during operation.

More specifically, teat cleaner 14 further comprises an outer housing 20 having an outer wall 22 and an inner wall 24, a cleaning fluid inlet nozzle 26 and a cleaning fluid discharge nozzle 28, and a cleaning fluid conduit 30 positioned between outer wall 22 and inner wall 24 and in fluid communication with cleaning fluid inlet nozzle 26. Teat cleaner 14 further comprises a brush housing 32 concentrically positioned within outer housing 20, and having an outer wall 34, an inner wall 36 defining a teat cleaning chamber 38, and a floor 40 having a plurality of drainage holes 42 formed therethrough and arranged in an annular path. Several vertically aligned sets of teat cleaning bristles 44, 46, and 48 engage and are positioned annularly around and extend radially inward from inner wall 24.

A motor 50 (i.e., an electric motor, air powered motor, hydraulic motor, hydro-powered motor, etc. . . . ) provides brush housing 32 with a source for rotary motion about longitudinal axis X-X. Motor 50 is positioned at the bottom of teat cleaner 14 and includes a coupling shaft 52 depending upwardly therefrom. A bearing plate 54 is attached via screws 56 to the upper surface of motor 50 and includes a centrally positioned opening 58 formed therethrough and through which coupling shaft 52 extends. A shaft housing 60, positioned partially within outer housing 30, is attached to the upper surface of bearing plate 54 via screws 62, and includes a bearing 64 extending centrally therethrough. A drive shaft 66 securely engaged with floor 40 of brush housing 32, extends through bearing 64 and operatively engages coupling shaft 52. Accordingly, the rotary motion generated by motor 50 is passed to brush housing 32 through coupling shaft 52 and drive shaft 66, thereby effecting rotary motion of brush housing 32 about longitudinal axis X-X. The rotary motion of brush housing 32 is, in turn, translated to bristle sets 44, 46, and 48.

The structure of teat cleaner 14 further comprises a cap 68 securely engaging the upper end of brush housing 32. Cap 68 includes a flanged edge 70 which extends over the outer wall 34, and a planar top surface 72 which includes an opening 74 formed therethrough for passage and directing of teat 12. Teat cleaner 14 engages teat 12 by passing the teat through opening 74 and into chamber 38. The length of bristles 44, 46, and 48 are sufficient so as to cause them to engage teat 12 when it passes into chamber 38. Cap 68 further serves to prevent cleaning fluid from escaping chamber 38 during the cleaning operation.

In operation, teat cleaner 14 receives a supply of cleaning fluid, such as water with a cleaning agent dispersed therein, through hose 16 which is connected to cleaning fluid inlet nozzle 26. The cleaning fluid then passes upwardly through conduit 30. The upper edge of conduit 30 includes a lip 76 which directs the cleaning fluid into teat cleaning chamber 38. The cleaning fluid supply is automatically or manually turned off once a predetermined time period has passed (i.e., after the cleaning process is complete as explained in greater detail hereinafter). The automatic turn off can be computer controlled by monitoring the time or volume of cleaning fluid passed into chamber 38.

Shortly after the cleaning fluid supply is turned on (e.g., 0.5-1.0 seconds), motor 50 is automatically or manually actuated, thereby causing teat cleaning bristles 44, 46, and 48 to begin rotating about longitudinal axis X-X and scrubbing teat 12. Motor 50 runs continuously for a predetermined period of time (e.g., 5-10 seconds) to effectively scrub teat 12. Upon completion of the predetermined time, the power to motor 50 is turned off.

Concurrently with the scrubbing process, a pressure source 80 is automatically actuated. Pressure source 80 creates a vacuum in chamber 38, thereby causing the cleaning fluid to pass through drainage holes 42, through discharge nozzle 28, and through hose 18. The suction created by the pressure source further serves to maintain a secure connection between cleaner 14 and teat 12.

The clean fluid supply is turned off either automatically or manually after a predetermined period of time. However, pressure source 80 remains actuated for a predetermined period of time following the shut off of the cleaning fluid in order to pull air through chamber 38 and dry teat 12. The time period for drying may be adjusted from animal to animal. Once dry, pressure source 80 is turned off and cleaner 14 is removed from teat 12.

Optionally, following the cleaning process, pressure source 80 may be increased to a predetermined level (e.g., 13-15 inches) for a predetermined period of time (e.g., 1 second). By applying this increased pressure to teat 12, a small amount of milk resident in the canal of teat 12 that may be contaminated will be withdrawn. This process, referred to as pre-stripping, ensures that essentially no contaminated milk will be milked from the animal during the milking operation.

All of the control aspects of cleaning apparatus 14 may be either manually controlled, or controlled with a micro processor which may have a user interface for adjusting the various cycle times.

What is claimed is:

1. An apparatus for cleaning a teat of an animal, such as a dairy cow, comprising:
a) a first housing having a longitudinal axis and an interior wall defining a teat cleaning compartment;
b) a first set of bristles engaged with said interior wall and extending radially inward therefrom; and
c) a device coupled to and adapted to impart rotary motion to said first set of bristles about said longitudinal axis.

2. The teat cleaning apparatus of claim 1, further comprising a second housing concentrically positioned around said first housing, and having a cleaning fluid inlet nozzle and a cleaning fluid discharge nozzle.

3. The teat cleaning apparatus of claim 2, further comprising a cleaning fluid conduit positioned in fluid communication with said cleaning fluid inlet nozzle and said teat cleaning compartment.

4. The teat cleaning apparatus of claim 2, further comprising a source of cleaning fluid positioned in fluid communication with said cleaning fluid inlet nozzle.

5. The teat cleaning apparatus of claim 2, further comprising a pressure source positioned in fluid communication with said cleaning fluid discharge nozzle.

6. The teat cleaning apparatus of claim 1, wherein said first housing further comprises a floor.

7. The teat cleaning apparatus of claim 6, wherein said floor further comprises a drainage hole formed therethrough.

8. The teat cleaning apparatus of claim 7, wherein said drainage hole is positioned in fluid communication with said cleaning fluid discharge nozzle.

9. The teat cleaning apparatus of claim 1, further comprising a cap positioned in at least partially covering relation to said first housing.

10. The teat cleaning apparatus of claim 9, wherein said cap includes an opening formed therethrough.

11. The teat cleaning apparatus of claim 1, wherein said device is a motor.

12. A method for cleaning a teat of an animal, such as a dairy cow, comprising the steps of:
a) placing said teat into a chamber formed in a teat cleaning device;
b) applying a pressure source to said device in order to create a negative pressure differential causing said device to be securely held in relation to said teat;
c) causing a cleaning fluid to flow into said chamber;
d) actuating a brush to rotate within said chamber and around said teat;
e) causing said cleaning fluid to drain from said chamber;
f) stopping said flow of cleaning fluid into said chamber;
g) removing said pressure source from said chamber; and
h) removing said teat from said chamber.

13. A method for cleaning a teat of an animal, such as a dairy cow, comprising the steps of:
a) placing said teat into a chamber formed in a teat cleaning device;
b) causing a cleaning fluid to flow into said chamber;
c) actuating a brush to rotate within said chamber and around said teat;
d) causing said cleaning fluid to drain from said chamber;
e) stopping said flow of cleaning fluid into said chamber; and
f) removing said teat from said chamber.
